(19) United States
(12) Patent Application Publication
(10) Pub. No.: US 2004/0008572 A1
(43) Pub. Date: Jan. 15, 2004

(54) Coaxial jet mixer nozzle with protruding centerbody and method for mixing two or more fluid components

(76) Inventor: Joseph Y. Stuart, Baton Rouge, LA (US)

Correspondence Address: Joseph Y. Stuart, 9945 Goodwood Boulevard, Baton Rouge, LA, 70815, US

(21) Appl. No.: 10/191,675

(22) Filed: Jul. 9, 2002

(51) Int. Cl. B01F 5/04

(52) U.S. Cl. 366/162.4

(57) ABSTRACT

Rapidly and intimately mixing a plurality of fluid substances. A nozzle assembly having a first nozzle comprising a flow duct with a convergent, tapered nozzle tip; one or more additional nozzles comprising a flow duct with a convergent, tapered nozzle tip wherein each subsequent nozzle is disposed coaxially around the preceding nozzle; and a centerbody disposed coaxially in the interior of the first nozzle, protruding beyond the discharge opening of the first nozzle around which an annular jet of liquid flowing in the annular space between the first nozzle and the centerbody is dispersed.

### BACKGROUND OF THE INVENTION

1. Field of the Invention

This invention relates generally to mixing fluid components and an apparatus for carrying out the mixing, and more particularly relates to an improved apparatus for mixing fluid components in processes where rapid and thorough mixing is beneficial.

2. Description of the Related Art

The following descriptions and examples are not admitted to be prior art by virtue of their inclusion within this section.

The effective mixing of fluids is important in many commercial processes. In particular, when one or more of the fluids is a liquid, effort is usually required to achieve sufficiently thorough, expedient mixing. When mixing is not sufficient, the effects of imperfect mixing are often seen as undesirable by-products.

The field of conventional mixing devices is broad. It can be roughly divided into two main areas: mechanical mixers and static mixers. Mechanical mixers rely on some type of moving part or parts to impart energy into the fluid components being mixed. Static mixers generally have no prominent moving parts, and instead rely on the pressure of one or more of the fluids to serve as the source of mixing energy. Conventional coaxial jet mixers are a type of static mixer. Coaxial jet mixers can be characterized by nozzle configurations comprising the shape, orientation, and positioning of surfaces which shape and orient the resulting fluid jets which are mixed.

Referring now to FIG. 1 there is shown a simple coaxial jet mixer nozzle assembly 100 for mixing two fluids. Simple coaxial jet mixer nozzle assembly 100 comprises inner flow duct 102 and an inner flow duct nozzle tip 104 disposed inside outer flow duct 101. Flow chamber 120 is defined as the space inside inner flow duct 102 and inner flow duct nozzle tip 104. Flow chamber 120 has two ends, supply end 130 and discharge end 110. Discharge end 110 of flow chamber 120 is formed by the discharge end of inner flow duct nozzle tip 104 and has a discharge opening of a given diameter. Flow chamber 121 begins as the annular space between outer flow duct 101 and inner flow duct 102. Flow chamber 121 continues as the annular space between outer flow duct 101 and inner flow duct nozzle tip 104. Flow chamber 121 has two ends, supply end 131 and discharge end 132. Discharge end 110 of flow chamber 120 and discharge end 132 of flow chamber 121 are substantially proximate in the axial dimension. The first fluid flows through flow chamber 120 and is discharged at discharge end 110 as jet 103. The initial diameter of jet 103 is equal to the discharge opening diameter of nozzle tip 104. The second fluid flows through flow chamber 121 and is discharged at discharge end 132 as annular jet 106. Jets 103 and 106 mix at their interface 105. The primary driving force for mixing is the differential velocity of jets 103 and 106. The difficulty of mixing is dependent in part on the diameter of inner jet 103 at discharge end 110 of flow duct nozzle tip 104. Consequently, the critical design issues for the coaxial jet mixer are the differential velocity of the fluids at discharge end 110 of inner flow duct nozzle tip 104 and the initial diameter of inner jet 103.

There are several potential variations on simple coaxial jet mixer nozzle assembly 100. FIG. 2 depicts a simple coaxial jet mixer nozzle assembly where outer flow duct 201 extends beyond the discharge end of inner flow duct nozzle tip 204, providing confined mixing space 206. U.S. Pat. No. 4,419,295 shows a simple coaxial jet mixer nozzle similar to that depicted in FIG. 2 applied in a commercial chemical process.

Referring now to FIG. 3 there is shown a conventional impinging coaxial jet mixer nozzle assembly 300 for mixing two fluids. Impinging coaxial jet mixer nozzle assembly 300 comprises inner flow duct 302 and an inner flow duct nozzle tip 304 disposed coaxially inside outer flow duct 301 and outer flow duct nozzle tip 305. Flow chamber 320 is defined as the space inside inner flow duct 302 and inner flow duct nozzle tip 304. Flow chamber 320 has two ends, supply end 330 and discharge end 310. Discharge end 310 of flow chamber 320 is formed by the discharge end of inner flow duct nozzle tip 304 and has a discharge opening of diameter D. Flow chamber 321 begins as the annular space between outer flow duct 301 and inner flow duct 302. Flow chamber 321 continues as the annular space between outer flow duct nozzle tip 305 and inner flow duct 302. Flow chamber 321 continues further as the annular space between outer flow duct nozzle tip 305 and inner flow duct nozzle tip 304. Flow chamber 321 has two ends, supply end 331 and discharge end 332. Discharge end 332 of flow chamber 320 is formed by the discharge end of outer flow duct nozzle tip 305. The first fluid flows through flow chamber 320 and is discharged at discharge end 310 as jet 303. Jet 303 has an initial diameter equal to D, the discharge opening diameter of nozzle tip 304. The second fluid flows through flow chamber 321 and is discharged at discharge end 332 as annular jet 306. The two concentric jets 303 and 306 collide and mix as they exit nozzle tips 304 and 305 to form composite jet 307. The primary driving force for mixing is the kinetic energy of jets 303 and 306. The difficulty of mixing is dependent in part on the initial diameter D of inner jet 303. Consequently, the critical design issues for coaxial jet mixer assembly 300 are the velocities of the fluids as they exit nozzle tips 304 and 305 and the initial diameter of inner jet 303. U.S. Pat. No. 1,547,349 depicts a conventional impinging coaxial jet mixer nozzle assembly and several variations of it.

In many applications, performance of simple coaxial jet mixer nozzle assembly 100 is limited due to practical limitations on the supply pressure of the fluid flowing through flow chamber 120. This limitation generally requires that the discharge opening diameter of the inner nozzle tip 104 be increased to accommodate higher flow rates. Since the initial diameter of jet 103 is equal to the discharge opening diameter of nozzle tip 104 and since the difficulty of mixing increases as the initial diameter of jet 103 is increased, mixing performance of simple coaxial jet mixer nozzle assembly 100 decreases as the discharge opening diameter of nozzle tip 104 is increased to allow higher flow rates. The trade-off between performance and throughput of simple coaxial jet mixer nozzle assembly 100 can be addressed by employing multiple, smaller-scale simple coaxial jet mixer nozzle assemblies 100 in parallel. The option of employing multiple, smaller-scale simple coaxial jet mixer nozzle assemblies 100 in parallel can be effective but can also be expensive, particularly in cases where separate metering systems for both fluids for each installed simple coaxial jet mixer nozzle assembly 100 are required.

In many applications, performance of simple coaxial jet mixer nozzle assembly 200 is limited due to practical limitations on the supply pressure of the fluid flowing through flow chamber 220. This limitation generally requires that the discharge opening diameter of the inner nozzle tip 204 be increased to accommodate higher flow rates. Since the initial diameter of jet 203 is equal to the discharge opening diameter of nozzle tip 204 and since the difficulty of mixing increases as the initial diameter of jet 203 is increased, mixing performance of simple coaxial jet mixer nozzle assembly 200 decreases as the discharge opening diameter of nozzle tip 204 is increased to allow higher flow rates. The trade-off between performance and throughput of simple coaxial jet mixer nozzle assembly 200 can be addressed by employing multiple, smaller-scale simple coaxial jet mixer nozzle assemblies 200 in parallel. The option of employing multiple, smaller-scale simple coaxial jet mixer nozzle assemblies 200 in parallel can be effective but can also be expensive, particularly in cases where separate metering systems for both fluids for each installed simple coaxial jet mixer nozzle assembly 200 are required.

In many applications, performance of impinging coaxial jet mixer nozzle assembly 300 is limited due to practical limitations on the supply pressure of the fluid flowing through flow chamber 320. This limitation generally requires that the discharge opening diameter of the inner nozzle tip 304 be increased to accommodate higher flow rates. Since the initial diameter of jet 303 is equal to the discharge opening diameter of nozzle tip 304 and since the difficulty of mixing increases as the initial diameter of jet 303 is increased, mixing performance of conventional impinging coaxial jet mixer nozzle assembly 300 decreases as the discharge opening diameter of nozzle tip 304 is increased to allow higher flow rates. The trade-off between performance and throughput of conventional impinging coaxial jet mixer nozzle assembly 300 can be addressed by employing multiple, smaller-scale conventional impinging coaxial jet mixer nozzle assemblies 300 in parallel. The option of employing multiple, smaller-scale conventional impinging coaxial jet mixer nozzle assemblies 300 in parallel can be effective but can also be expensive, particularly in cases where separate metering systems for both fluids for each installed conventional impinging coaxial jet mixer nozzle assembly 300 are required.

Referring now to FIG. 5A, there is shown radial, cross-sectional view 501 of jets 303 and 306 at the axial position of discharge end 310 of inner flow duct nozzle tip 304 of impinging coaxial jet mixer nozzle assembly 300. D₁ denotes the diameter of inner jet 303 at the axial position of discharge end 310 of inner flow duct nozzle tip 304. FIG. 5A is consistent with FIG. 3 in the case of a single impinging coaxial jet mixer nozzle assembly where D of FIG. 3 is equal to D₁ of FIG. 5A.

Referring now to FIG. 5B, there is shown radial, cross-sectional view 502 of 25 sets of jets 303 and 306 at the axial position of discharge end 310 of inner flow duct nozzle tip 304 of 25 impinging coaxial jet mixer nozzle assemblies 300. D₂ refers to the diameter of each individual inner jet 303 at the axial position of discharge end 310 of each individual inner flow duct nozzle tip 304. FIG. 5B is consistent with FIG. 3 in the case of a multiple impinging coaxial nozzle assemblies where D of FIG. 3 is equal to D₂ of FIG. 5B.

FIG. 5A and FIG. 5B are presented to show the relative effect of substituting multiple, smaller-scale conventional impinging coaxial jet mixer nozzle assemblies 300 in parallel to replace one full-scale impinging coaxial jet mixer nozzle assembly 300. The single inner jet 303 of FIG. 5A will have the same hydraulic capacity as the 25 inner jets 303 of FIG. 5B if the radial cross-sectional area of the single inner jet 303 of FIG. 5A is equal to the radial cross-sectional area of the 25 inner jets 303 of FIG. 5B. In general, one can calculate N, the number of nozzle assemblies 300 that can be installed in parallel in order to achieve similar hydraulic performance to one nozzle assembly 300 of design 300 as shown in Eq. (1):

N=D₁²/D₂² (1)

where D₁ denotes the diameter of inner jet 303 at the axial position of discharge end 310 of inner flow duct nozzle tip 304 for the single nozzle assembly 300 and D₂ denotes the diameter of inner jet 303 at the axial position of discharge end 310 of inner flow duct nozzle tip 304 for the N smaller-scale nozzle assemblies 300.

An example illustrates the use of Eq. (1). Given an impinging coaxial jet mixer nozzle assembly 300 with jet 303 having a diameter of 30 millimeters at the axial position of discharge end 310 of inner flow duct nozzle tip 304 and a need to improve mixing performance to that observed with a nozzle of the same design but with jet 303 diameter of 6 millimeters at the axial position of discharge end 310 of inner flow duct nozzle tip 304, how many parallel impinging coaxial jet mixer nozzle assemblies 300 would be required? In this example, D₁=30 mm, D₂=6 mm, and N=(30×30)/(6×6)=25. Therefore, about 25 impinging coaxial jet mixer nozzle assemblies 300 would be required to operate in parallel to achieve the specified mixing performance while achieving the same hydraulic performance of the single impinging coaxial jet mixer nozzle assembly 300.

There continues to be increased interest in higher-efficiency mixing systems by chemical producers, chemical processors, and energy companies. Furthermore, as the scale of commercial processes increases, the effectiveness of conventional coaxial jet mixing nozzles is reduced. Therefore, there is a need for a mixing nozzle which provides mixing performance beyond that of conventional impinging coaxial jet-mixing nozzle 300.

### BRIEF DESCRIPTION OF THE DRAWINGS

Other features and advantages of the invention will become apparent upon study of the following description, taken in conjunction with the attached FIGS. 1-12.

FIG. 1 is an axial, cross-sectional view of a conventional simple coaxial jet mixer nozzle assembly;

FIG. 2 is an axial, cross-sectional view of a conventional simple coaxial jet mixer nozzle assembly with an extended outer flow duct;

FIG. 3 is an axial, cross-sectional view of a conventional impinging coaxial jet mixer nozzle assembly;

FIG. 4 is an axial, cross-sectional view of an impinging coaxial jet mixing nozzle assembly with a protruding centerbody, in accordance with an embodiment of the present invention;

FIG. 5A is a radial, cross-sectional view of jets 303 and 306 at discharge end 310 of flow duct nozzle tip 304 for conventional impinging coaxial jet mixer nozzle assembly 300;

FIG. 5B is a radial, cross-sectional view of 25 sets of jets 303 and 306 at discharge end 310 of flow duct nozzle tips 304 for a system of 25 smaller-scale, conventional impinging coaxial jet mixer nozzle assemblies 300 with equivalent hydraulic capacity to the one conventional impinging coaxial jet mixer nozzle assembly 300 of FIG. 5A;

FIG. 5C is a radial, cross-sectional view of jets 403 and 406 and centerbody 407 at discharge opening 410 of flow duct nozzle tip 404 for impinging coaxial jet mixing nozzle assembly 400 with equivalent hydraulic capacity to the one conventional impinging coaxial jet mixer nozzle assembly 300 of FIG. 5A and similar mixing efficiency to the system of 25 smaller-scale, conventional impinging coaxial jet mixer nozzle assemblies 300 of FIG. 5B.

FIG. 6 is an axial, cross-sectional view of an impinging coaxial jet mixer nozzle with a protruding centerbody in accordance with a preferred embodiment of the present invention;

FIG. 7 is an axial, cross-sectional view of an alternative embodiment of the present invention having a cylindrical, protruding centerbody;

FIG. 8 is an axial, cross-sectional view of an alternative embodiment of the present invention having a truncated, conically-tapered, protruding centerbody;

FIG. 9 is an axial, cross-sectional view of the present invention showing key dimensions for explaining alternative embodiments based on centerbody diameter;

FIG. 10 is a set of radial cross-sectional views of alternative embodiments of the centerbody geometry where the radial cross-sections are either regular polygons and star polygons in shape;

FIG. 11 is a set of radial cross-sectional views of alternative embodiments of the centerbody geometry where the radial cross-sections are rectangular in shape; and

FIG. 12 is an axial, cross-sectional view of an alternative embodiment of the present invention for mixing three fluids.

FIG. 13 is an axial, cross-sectional view of an alternative embodiment of the present invention having discharge ends of the inner flow duct nozzle tip and the outer flow duct nozzle dip which are not proximal.

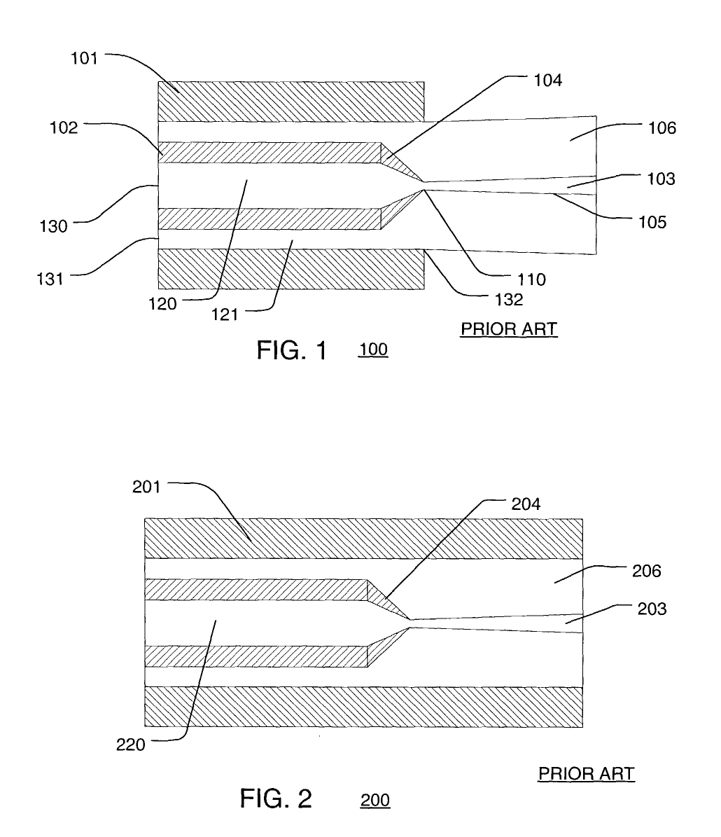

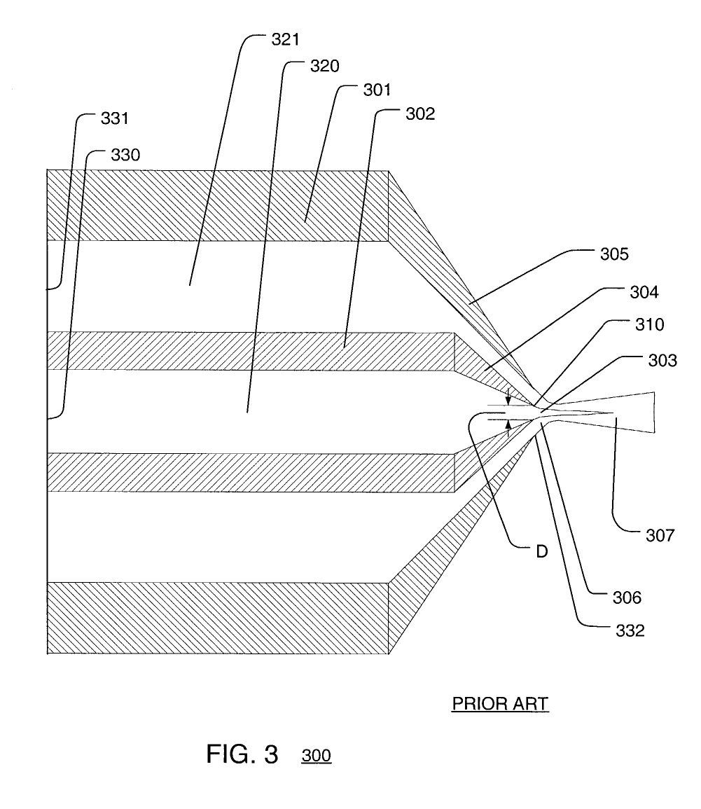

### DETAILED DESCRIPTION OF THE INVENTION

The present invention comprises an impinging coaxial jet mixing nozzle assembly with a protruding centerbody and a process, employing said assembly, for rapidly and intimately mixing two or more fluid components. This invention improves upon conventional impinging coaxial jet mixer nozzle assemblies by distributing the inner fluid jet around the protruding centerbody, reducing the thickness of the inner fluid jet, and improving mixing performance to that normally associated with smaller-scale conventional impinging coaxial jet mixer nozzle assemblies. Further details, advantages, and embodiments of the invention are described below with reference to the Figures.

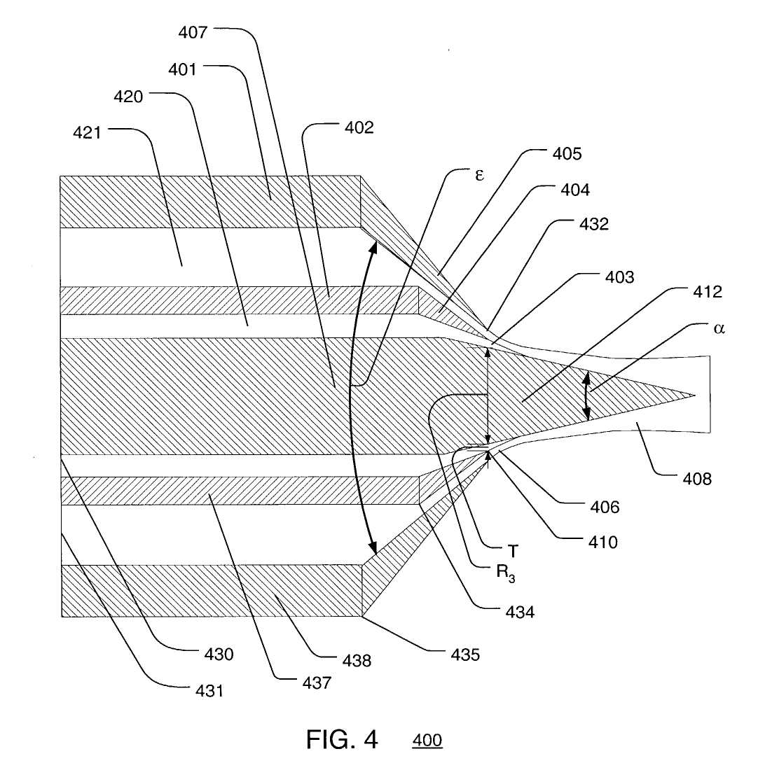

Referring now to FIG. 4, there is shown an impinging coaxial jet mixing nozzle assembly with protruding centerbody for mixing two fluids in accordance with an embodiment of the present invention. Impinging coaxial jet mixing nozzle assembly 400 comprises a second (outer) nozzle subassembly (or nozzle for short) 438, first (inner) nozzle subassembly (or nozzle for short) 437, and centerbody 407. Centerbody 407 is disposed coaxially inside inner nozzle 437, which is itself disposed coaxially inside outer nozzle 438. Outer nozzle 438 comprises a substantially cylindrical outer flow duct portion 401 as well as a convergent, tapered tip portion 405. Tip portion 405 is tapered at angle ε and has a second or outer discharge opening 432. Inner nozzle 437 comprises a substantially cylindrical inner flow duct portion 402 as well as a convergent, tapered tip portion 404, which has a first or inner discharge opening 410. Centerbody 407 comprises a substantially cylindrical main body portion completely inside first nozzle, and the tapered tip portion or member 412. The main body portion of centerbody 407 is wholly inside inner nozzle 437, and a part of centerbody tip 412 protrudes through discharge opening 410 of inner nozzle 437, during operation of the nozzle assemble 400. The terms coaxial and coaxially refer to the configuration of nozzle components along coincident axes, the axes being perpendicular to the radial cross section of the components where the axes passing through the center of the cross-sectional shapes.

In an embodiment, the diameter of the main body portion of centerbody 407 is larger than the diameter of discharge opening 410, and centerbody 407 is movable axially relative to first nozzle 437, so that centerbody 407 can seal (close) the discharge opening 410. In an embodiment, the outer diameter of the inner flow duct 402 is larger than the diameter of discharge opening 432 of second nozzle tip 405, and first nozzle 437 is movable axially relative to second nozzle 438, so that first nozzle tip 404 can seal (close) the discharge opening 432.

In an embodiment, protruding tip 412 of centerbody 407 is tapered conically at angle α Thus, centerbody 407 has protruding tip 412 which tapers down from the substantially cylindrical, main body portion of centerbody 407. At least a part of this protruding member or portion of centerbody 407 extends axially beyond first discharge opening 410. Outer flow duct nozzle tip 405 is disposed coaxially around inner flow duct nozzle tip 404 where discharge opening 410 of inner flow duct nozzle tip 404 and discharge opening 432 of outer flow duct nozzle tip 405 are axially proximate, during operation of the nozzle assembly 400. Inner flow duct 402 is disposed coaxially to outer nozzle 438 and attached to the larger end 434 of inner duct nozzle tip 404; and outer flow duct 401 attached to the larger end 435 of outer duct nozzle tip 405.

Flow chamber 420 begins as the annular space between inner flow duct 402 and centerbody 407. Flow chamber 420 continues as the annular space between inner flow duct nozzle tip 404 and centerbody 407. Flow chamber 420 has two ends, supply end 430 and a discharge end at discharge opening 410 of inner flow duct nozzle tip 404. Flow chamber 421 begins as the annular space between outer flow duct 401 and inner flow duct 402. Flow chamber 421 continues as the annular space between outer flow duct nozzle tip 405 and inner flow duct 402. Flow chamber 421 continues further as the annular space between outer flow duct nozzle tip 405 and inner flow duct nozzle tip 404. Flow chamber 421 has two ends, supply end 431 and a discharge end 432 at outer discharge opening 432 of outer flow duct nozzle tip 405.

In operation of nozzle assembly 400, the first fluid flows through flow chamber 420 and is discharged through discharge opening 410 around the perimeter of protruding tip 412 of centerbody 407 as inner annular jet 403. The second fluid flows through flow chamber 421 and is discharged through discharge opening 432 as outer annular jet 406. The two concentric jets 403 and 406 collide and mix as they exit nozzle tips 404 and 405. The mixed streams form composite jet 408. Because of the presence of the protruding portion of tip 412, the inner annular jet 403 does not collapse, but is rather distributed out along the outer surface of protruding tip 412, so that outer annular jet 406 can rapidly and intimately mix with the inner annular jet. Without the presence of protruding portion 412, the inner jet would not be annular, and would be more difficult to mix as the diameter of the inner non-annular jet would be greater than the thickness of the inner annular jet. The increased ease of mixing associated with the inner annular jet is of particular benefit in processes where rapid, competing chemical reactions occur immediately as the two fluids are mixed.

The primary driving force for mixing is the kinetic energy of jets 403 and 406. The difficulty of mixing is dependent in part on the initial thickness T of annular jet 403. Initial thickness T of annular jet 403 is one half of the difference of the diameter of inner flow duct nozzle tip 404 and the diameter of protruding tip 412 of centerbody 407, both diameters measured at the axial position of discharge opening 410 of inner flow duct nozzle tip 404. Consequently, the critical design issues for impinging coaxial jet mixing nozzle assembly 400 are the velocities of fluid jets 403 and 406 as they exit nozzle tips 404 and 405, the diameter of inner flow duct nozzle tip 404, and the diameter of protruding tip 412 of centerbody 407 where both diameters are measured at the axial position of point of initial discharge 410 from inner flow duct nozzle tip 404. In addition, angle α of member 412 and the distance which member 412 protrudes beyond discharge opening 410 are critical design issues for impinging coaxial jet mixing nozzle assembly 400. Angle α is preferably less than or equal to the angle ε, the angle at which the inside surface of outer nozzle tip 405 is tapered. Optimal performance of impinging coaxial jet mixing nozzle assembly 400 is expected occur somewhere in the range where ε-α is between 40 degrees and 140 degrees. The distance which member 412 protrudes beyond discharge opening 410 is preferably sufficiently long such that inner annular jet 403 is substantially mixed with annular jet 406 before the end of member 412 is reached by annular jet 403.

Thus, apparatus 400 can be employed for mixing at least first and second fluids, the apparatus comprising: first nozzle comprising flow duct 402 and flow duct nozzle tip 404 having first discharge opening 410; second nozzle comprising flow duct 401 and tapered nozzle tip 405 disposed coaxially around the first nozzle and having a second discharge opening 432 substantially axially aligned with discharge opening 410 of the first nozzle, outer flow chamber 421 being defined between the second nozzle and the first nozzle; and centerbody 407 disposed coaxially inside the first nozzle and having a protruding tip 412 protruding axially through discharge opening 410 of the first nozzle, inner flow chamber 420 being defined between the first nozzle and the centerbody 407, where during operation of apparatus 400, the first fluid flowing in inner flow chamber 420 and exiting through first discharge opening 410 forms inner annular fluid jet 403 that is dispersed around said protruding tip 412 of centerbody 407; the second fluid flowing in outer flow chamber 421 forms at second discharge opening 432 second annular fluid jet 406 that impinges upon first annular fluid jet 403, thereby mixing the first and second fluid jets.

The nozzle assembly of the present invention thus provides an apparatus for mixing at least first and second fluids, the apparatus comprising first nozzle assembly means for forming a first annular fluid jet 403, consisting of the first fluid, at first axial discharge position (i.e., the axial position of discharge opening 410); a protruding member (the protruding portion of protruding tip 412) substantially coaxial with and inside first annular fluid jet 403 and protruding axially beyond the first axial discharge position (position of opening 410). This causes the first annular fluid jet 403 to be dispersed around the protruding member. The nozzle assembly of the present invention also provides a second nozzle assembly means for forming a second annular fluid jet 406 coaxial with and around first annular fluid jet 403, the second annular fluid jet consisting of the second fluid, wherein second annular fluid jet 406 is formed at a second axial discharge position (the axial position of opening 432) so that second annular fluid jet 406 impinges upon first annular fluid jet 403 as first annular fluid jet 403 is dispersed around said protruding portion, thereby mixing the first and second fluids.

The present invention also provides a corresponding method for mixing at least first and second fluids, which includes forming first annular fluid jet 403, consisting of the first fluid, at a first axial discharge position 410 and dispersing first annular fluid jet 410 around protruding member 412 substantially coaxial with and inside first annular fluid jet 403 and protruding axially beyond first axial discharge position 410; and forming second annular fluid jet 406 coaxial with and around the annular fluid jet 403 and consisting of the second fluid at a second axial discharge position 432 so that second annular fluid jet 406 impinges upon first annular fluid jet 403 as first annular fluid jet 403 is dispersed around said protruding portion, thereby mixing the first and second fluids.

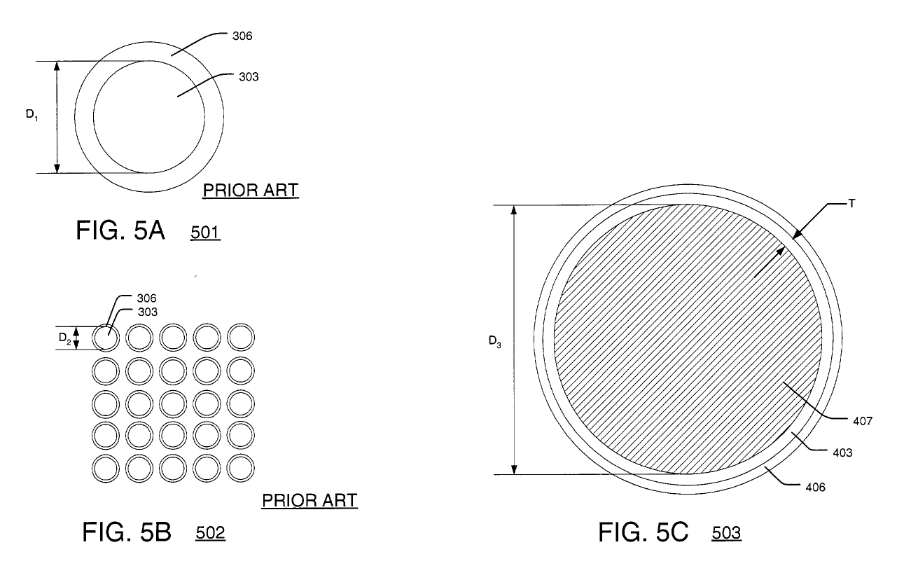

Referring now to FIG. 5C, there is shown radial, cross-sectional view 503 of inner annular jet 403, outer annular jet 406, and centerbody 407 at the axial position of discharge opening 410 of inner flow duct nozzle tip 404 of impinging coaxial jet mixing nozzle assembly 400. T denotes the thickness of annular jet 403 at the axial position of discharge opening 410 of inner flow duct nozzle tip 404. D₃ denotes the diameter of centerbody 407 at the axial position of discharge opening 410 of inner flow duct nozzle tip 404.

FIG. 5C is presented with FIG. 5B to show the relative effect of substituting one single impinging coaxial jet mixer nozzle assembly 400 of the present invention for multiple, smaller-scale conventional impinging coaxial jet mixer nozzle assemblies 300 in parallel. The single inner annular jet 403 of FIG. 5C will have about the same hydraulic capacity as the 25 inner annular jets 303 of FIG. 5B if the radial cross-sectional area of the single inner annular jet 403 of FIG. 5C is equal to the radial cross-sectional area of the 25 inner annular jets 303 of FIG. 5B. The difficulty of mixing with 25 conventional impinging coaxial jet mixers 300 is dependent in part on the initial diameter D₂ of inner annular jets 303. FIG. 5B shows the initial diameter D₂ of 25 inner jets of 25 impinging coaxial jet mixer nozzle assemblies 300 with equivalent hydraulic capacity to the single inner annular jet 403 of FIG. 5C.

In general, one can calculate N, the number of conventional impinging coaxial jet mixer nozzle assemblies 300 that can be employed in parallel to achieve equivalent hydraulic performance of one conventional impinging coaxial jet mixer nozzle assembly 300 with Eq. (1). The mixing performance of N multiple conventional impinging coaxial jet mixer nozzle assemblies 300 operating in parallel will be greater than that of the single impinging coaxial jet mixer nozzle assembly 300, as D₂ will be less than D₁ . The mixing performance of a system of N conventional impinging coaxial jet mixer nozzle assemblies 300 with initial inner-fluid jet diameters D₂ operating in parallel can be approximated by one impinging coaxial jet mixer nozzle assembly 400 where the dimensions T and D₃ are set by Eq. (2) and Eq. (3):

T=D₂/2 (2)

D₃=(N D₂²/4T)−T (3)

An example illustrates the use of the Eqs. (1), (2), and (3). Given a conventional impinging coaxial jet mixer assembly 300 with dimension D of 30 mm and a need to improve mixing performance to that observed with a conventional impinging coaxial jet mixer 300 with dimension D of 6 mm, how many impinging coaxial jet mixer assemblies 300 would be required to operate in parallel to achieve both the hydraulic capacity and the required mixing performance? What would the dimensions T and D₃ be of one impinging coaxial jet mixer assembly 400 which would achieve the required hydraulic capacity and mixing performance? In this example, D₁=30 mm, D₂=6 mm, and N=(30×30)/(6×6)=25. Therefore, 25 impinging coaxial jet mixer nozzle assemblies 300 would be required to operate in parallel to achieve the specified mixing performance while delivering the same hydraulic performance of the single impinging coaxial jet mixer nozzle assembly 300. Coaxial jet mixer 400 can achieve the required hydraulic capacity and mixing performance. Using Eq. (2), T=D₂/2=3 mm. Using Eq. (3), D₃=(25×6×6)/(4×3)−3=72 mm. Therefore, both the desired mixing performance and hydraulic performance specified can be achieved by employing impinging coaxial jet mixer 400 with centerbody 407 positioned relative to inner flow duct nozzle tip 404 to produce inner fluid jet 403 with thickness T of 3 millimeters around protruding tip 412 of centerbody 407 where protruding tip 412 of centerbody 407 has diameter D₃ of 72 mm at the axial position of discharge opening 410 of inner flow duct nozzle tip 404.

The ability to achieve the mixing performance typically achieved by using multiple, smaller-scale impinging coaxial jet mixer assemblies 300 with only one mixing nozzle assembly 400 is advantageous in commercial processes where metering and flow-control of all streams may be required in order to ensure proper operation. In the example above, the 25 impinging coaxial jet mixer nozzle assemblies 300 operating in parallel can require the installation of 50 flow-control loops to ensure the proper flow of each of the streams to be mixed to each of the 25 smaller-scale impinging coaxial jet mixer nozzle assemblies 300.

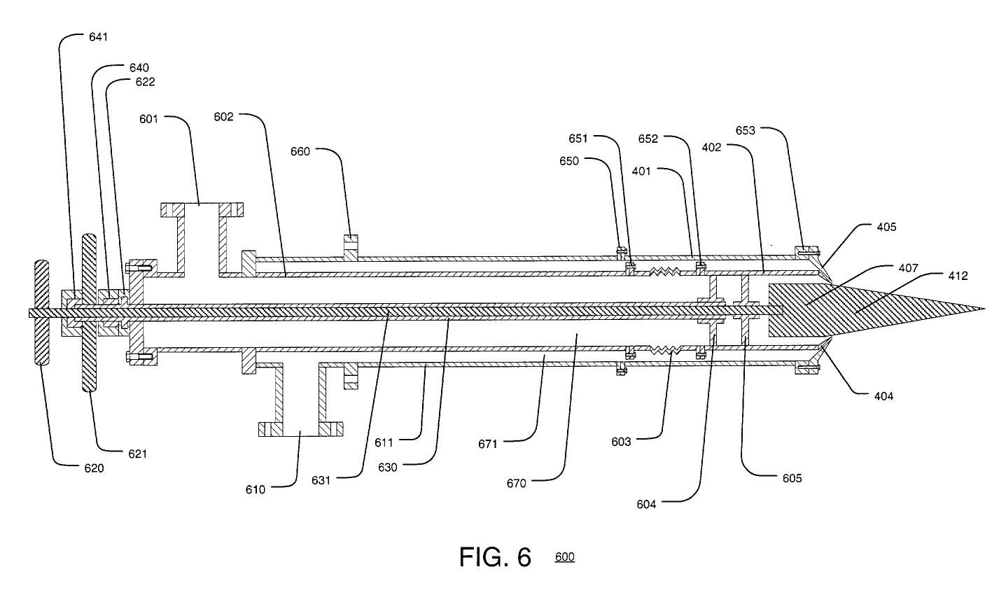

Referring now to FIG. 6, there is shown impinging coaxial jet mixer assembly 600, a preferred embodiment of the present invention. Impinging coaxial jet mixer nozzle assembly 600 comprises an impinging coaxial jet mixer nozzle 400 with a protruding centerbody 407, mechanical means for adjustment of the axial position of centerbody 407, mechanical means for adjustment of the axial position of inner flow duct nozzle tip 404, flow ducts 670 and 671 to supply fluids to inner and outer nozzle tips 404 and 405, and mechanical seals 640 and 641 for preventing leakage of the fluids.

Impinging coaxial jet mixer assembly 600 includes spider assemblies 604 and 605. Each spider assembly comprises a hub with radiating arms. The distal ends of the radiating arms of spider assemblies 604 and 605 are affixed to the inside of inner flow duct 402. Outer shaft 630 fits through the hub of spider assembly 604. Outer shaft 630 and the hub of spider assembly 604 have matching threaded surfaces. The threaded portion of outer shaft 630 extends beyond the hub of spider assembly 604 to allow adequate travel of spider assembly 604 along outer shaft 630. Inner shaft 631 fits through the hub of spider assembly 605. Inner shaft 631 and the hub of spider assembly 605 have matching threaded surfaces. The threaded portion of inner shaft 631 extends beyond the hub of spider assembly 605 to allow adequate travel of spider assembly 605 along outer shaft 631.

There are two flow chambers in impinging coaxial jet mixer assembly 600. The upstream side of flow chamber 670 begins with the internal space defined by inlet nozzle 601. Flow chamber 670 continues into the space between inner flow duct 602 and outer shaft 630. Flow chamber 670 continues into the space between expansion joint 603 and outer shaft 630. Flow chamber 670 continues into the space between inner flow duct 402 and outer shaft 630, including openings in spider assembly 604. Flow chamber 670 continues into the space between inner flow duct 402 and inner shaft 631, including openings in spider assembly 605. Flow chamber 670 continues into the space between inner flow duct 402 and centerbody 407. Flow chamber 670 continues into the space between inner flow duct nozzle tip 404 and centerbody 407. The upstream side of flow chamber 671 begins with the internal space defined by inlet nozzle 610. Flow chamber 671 continues into the space between outer flow duct 611 and inner flow duct 602. Flow chamber 671 continues into the space between outer flow duct 401 and inner flow duct 602. Flow chamber 671 continues into the space between outer flow duct 401 and expansion joint 603. Flow chamber 671 continues into the space between outer flow duct 401 and inner flow duct 402. Flow chamber 671 continues into the space between outer flow duct nozzle tip 405 and inner flow duct 402. Flow chamber 671 continues into the space between outer flow duct nozzle tip 405 and inner flow duct nozzle tip 404.

Two fluids are mixed in impinging coaxial jet mixer assembly 600. The first fluid flows through flow chamber 670 and is discharged as inner annular jet 403 flowing around the perimeter of protruding tip 412 of centerbody 407. The second fluid flows through flow chamber 671 and is discharged from the nozzle as outer annular jet 406. The two concentric jets collide and mix as they exit nozzle tips 404 and 405. The mixed streams form fluid jet 408 which flows around the perimeter of protruding tip 412 of centerbody 407.

Impinging coaxial jet mixer assembly 600 also provides for adjustment of the axial position of both inner flow duct nozzle tip 404 and centerbody 407. Axial movement of nozzle tip 404 with relation to nozzle tip 405 is achieved by rotating hand wheel 621 which rotates outer shaft 630. The axial position of outer shaft 630 is fixed by thrust bearing assembly 622. As outer shaft 630 is rotated, it produces an axial force on spider assembly 604 and moves inner flow duct 402 and inner flow duct nozzle tip 404 axially. The ability of inner flow duct 402 and inner flow duct nozzle tip 404 to move axially in provided by expansion joint 603, which either compresses or expands as inner flow duct 402 and inner flow duct nozzle tip 404 move along their axial paths. The net result is that turning hand wheel 621 enables on-line adjustment of the relative axial position of inner flow duct nozzle tip 404 to outer flow duct nozzle tip 405. As the relative axial position of inner flow duct nozzle tip 404 to outer flow duct nozzle tip 405 is adjusted, the radial cross-sectional area for flow between 404 and 405 is adjusted, changing the thickness of impinging outer annular jet 406.

Axial movement of centerbody 407 relative to the inner flow duct nozzle tip 404 is achieved by a mechanical linkage connected to hand wheel 620. Hand wheel 620 is affixed to inner shaft 631 which is free to move axially. When hand wheel 620 is rotated, inner shaft 631 rotates. As inner shaft 631 rotates, spider assembly 605 produces an axial force on inner shaft 631. Therefore, the turning of hand wheel 620 causes inner shaft 631 to move axially. Centerbody 407 is affixed to inner shaft 631. The net result is that the axial position of centerbody 407 can be adjusted by rotating hand wheel 620. As the relative axial position of centerbody 407 to inner flow duct nozzle tip 404 is adjusted, the radial cross-sectional area for flow between inner flow duct nozzle tip 404 and centerbody 407 is adjusted, changing initial thickness T of inner annular jet 403.

Impinging coaxial jet mixer assembly 600 includes several sets of flanges to facilitate assembly, maintenance, and modification. Numerals 650, 651, 652, and 653 all refer to such flanges. Flange 660 is included to enable mounting of the mixer onto a reactor vessel. Numerals 640 and 641 refer to mechanical seal assemblies which provide seals around rotating shafts 630 and 631 preventing the leakage of either fluid.

Impinging coaxial jet mixer assembly 600 also includes sealing surfaces between protruding tip 412 of centerbody 407 and inner flow duct nozzle tip 404 as well as between inner flow duct nozzle tip 404 and outer flow duct nozzle tip 405. Sealing surfaces between protruding tip 412 of centerbody 407 and inner flow duct nozzle tip 404 enable the complete blockage of flow through flow chamber 670. Sealing surfaces between inner flow duct nozzle tip 404 and outer flow duct nozzle tip 405 enable the complete blockage of flow through flow chamber 671. Sealing surfaces between protruding tip 412 of centerbody 407 and inner flow duct nozzle tip 404 are produced through a lapping process during fabrication. Sealing surfaces between inner flow duct nozzle tip 404 and outer flow duct nozzle tip 405 are produced through a lapping process during fabrication. The lapping process produces sets of parts with matched, close-fitting surfaces by polishing or grinding. Where geometry allows, lapping of surfaces can be easily achieved by holding one part stationary while rotating the other part with the sealing surfaces in contact. An abrasive compound is often used to facilitate the grinding and polishing processes to produce lapped, sealing surfaces. Sealing surfaces between protruding tip 412 of centerbody 407 and inner flow duct nozzle tip 404 and between inner flow duct nozzle tip 404 and outer flow duct nozzle tip 405 can be achieved by holding one part stationary while rotating the other part with the sealing surfaces in contact, with or without an abrasive compound.

By moving centerbody 407 relative to first nozzle tip 404, first discharge opening 410 may be closed, thereby sealing the inner flow chamber; and by moving first nozzle tip 404 relative to second nozzle tip 405, the outer flow chamber may also be sealed.

The preferred embodiment of the current invention may be employed as a pre-phosgenation reactor for the preparation of isocyanates. In this embodiment, the fluid flowing through the inner path is a primary amine, optionally dissolved in a solvent. In this embodiment, the fluid flowing through the outer path is a phosgene dissolved in an organic solvent.

Thus, the preferred embodiment of the current invention provides several advantages over conventional impinging coaxial jet mixer nozzle assembly 300. One advantage is a reduction in thickness of the inner jet stream to be mixed, similar to that achieved with multiple smaller-scale impinging coaxial jet mixer nozzle assemblies 300 operating in parallel but without the complexity and cost of multiple mixer nozzle assemblies and multiple metering systems for each fluid. Another advantage is the on-line adjustability of the radial cross-sectional area for flow of both the inner and outer jet streams. On-line adjustability denotes the ability to make adjustments without undue interference with an ongoing process. In commercial scale processes, on-line adjustability allows for frequent adjustment of the nozzles for maximum pressure drop at the discharge point of the nozzle, thereby maximizing mixing energy and mixing performance, while allowing the required flows to pass. Another advantage is improved turn-down capability of commercial processes. Fixed mixer nozzle assemblies tend to have limited ranges for optimal operation. The adjustability of the preferred embodiment of this invention will allow a wider range of operating rates for some processes. Another advantage is on-line sealing and opening of the flow chambers at or near the discharge end of the nozzle assembly. Commercial processes often include installed-spare mixer nozzle assemblies. A problem with installed-spare mixer nozzle assemblies is that reactor contents can flow back into the flow chambers and form deposits which block the flow chambers or disrupt the mixing process when the spare mixer nozzle assembly is placed into service. The sealing ability of the preferred embodiment allows for the flow chambers to be closed at or near the discharge end of the nozzle assembly, preventing the backflow of reactor contents and the possibility of subsequent operational problems. A fifth advantage is the ability to stroke centerbody 407 through its full travel path with the nozzle assembly installed. Commercial scale mixer assemblies can become plugged with debris. Stroking centerbody 407 closed can crush some types of debris lodged between centerbody 407 and inner flow duct nozzle tip 404. Stroking centerbody 407 open can allow debris lodged between centerbody 407 and inner flow duct nozzle tip 404 to pass. The ability to stroke centerbody 407 to clear pluggage at the discharged end of inner fluid flow chamber 670 is generally preferred to the alternative of shutting down a process to remove the nozzle assembly from service and replace it with a clean, unplugged nozzle assembly. A sixth advantage is the ability to stroke inner flow duct nozzle tip 404 through its full travel path with the nozzle assembly installed. Commercial scale mixer assemblies can become plugged with debris. Stroking inner flow duct nozzle tip 404 closed can crush some types of debris lodged between inner flow duct nozzle tip 404 and outer flow duct nozzle tip 405. Stroking inner flow duct nozzle tip 404 open can allow debris lodged between inner flow duct nozzle tip 404 and outer flow duct nozzle tip 405 to pass. The ability to stroke inner flow duct nozzle tip 404 to clear pluggage at the discharge end of outer fluid flow chamber 671 is generally preferred to the alternative of shutting down a process to remove the nozzle assembly from service and replace it with a clean, unplugged nozzle assembly.

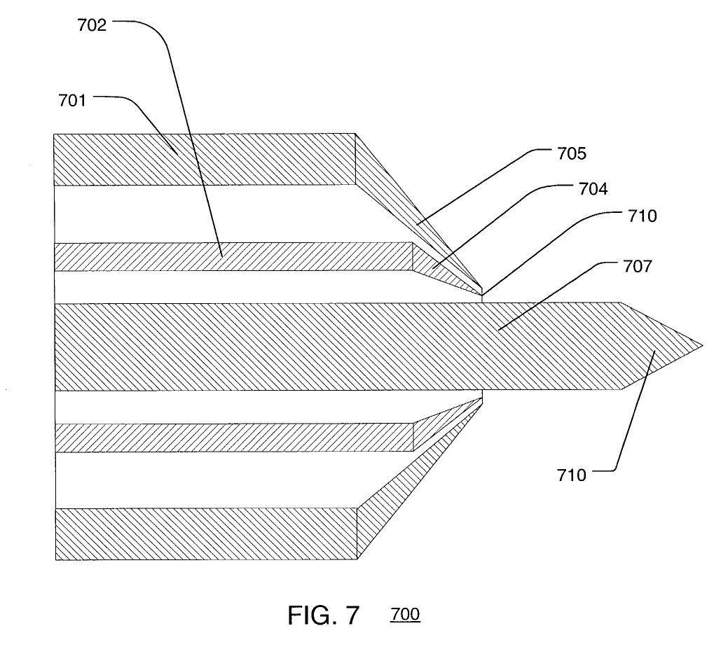

Referring now to FIG. 7, alternative embodiment 700 of the present invention is shown. Nozzle assembly 700 is an impinging coaxial jet mixer nozzle with a cylindrical protruding centerbody. Nozzle assembly 700 comprises inner flow duct 702 disposed inside outer flow duct 701, a convergent tip 705 affixed to the discharge end of outer flow duct 701, a convergent tip 704 affixed to the discharge end of the inner flow duct 702, and protruding coaxial centerbody 707. In contrast to the preferred embodiment shown in FIG. 4, the portion of centerbody 707 at the axial position of discharge end 710 of inner flow duct nozzle tip 704 is cylindrical rather than conical. FIG. 7 also shows conical tip 710 at the end of the cylindrical protruding centerbody. Many shapes can be substituted for the conical tip. The cylindrical protruding centerbody will provide the mixing benefits of the conical centerbody of the preferred embodiment, but will not allow for the sealing surfaces between centerbody 707 and inner flow duct nozzle tip 704.

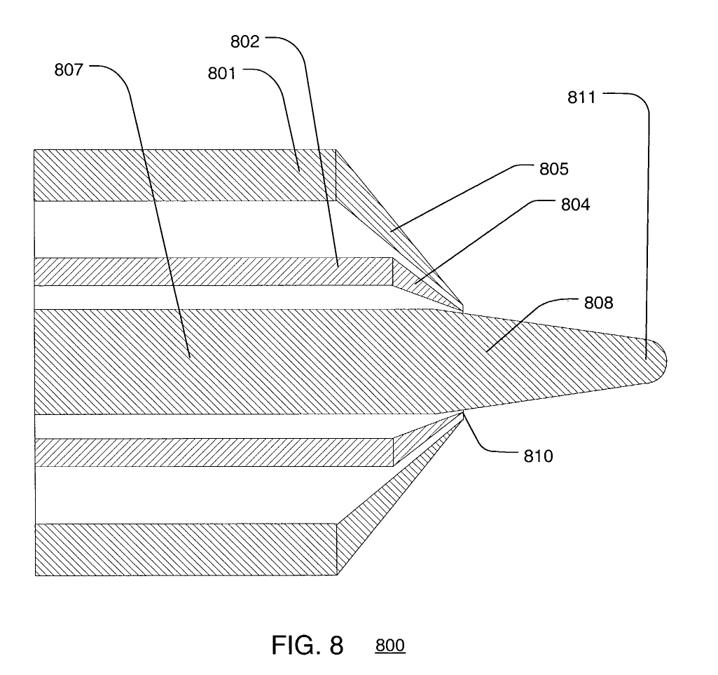

Referring now to FIG. 8, alternative embodiment 800 of the present invention is shown. Nozzle assembly 800 is an impinging coaxial jet mixer nozzle with a truncated-conical, protruding centerbody. Nozzle assembly 800 comprises inner flow duct 802 disposed inside outer flow duct 801, a convergent tip 805 affixed to the discharge end of outer flow duct 801, a convergent tip 804 affixed to the discharge end of the inner flow duct 802, and coaxial centerbody 807 having truncated conical section 808 and tip 811. In contrast to the preferred embodiment shown in FIG. 4, the portion of centerbody 807 protruding through discharge opening 810 of inner flow duct nozzle tip 804 is a truncated cone. FIG. 8 also shows hemispherical tip 811 at the end of the truncated conical portion of the centerbody. Many shapes can be substituted for the hemispherical tip shown. The truncated-conical centerbody will provide the mixing benefits of the regular conical centerbody of the preferred embodiment while reducing the overall length of the mixer.

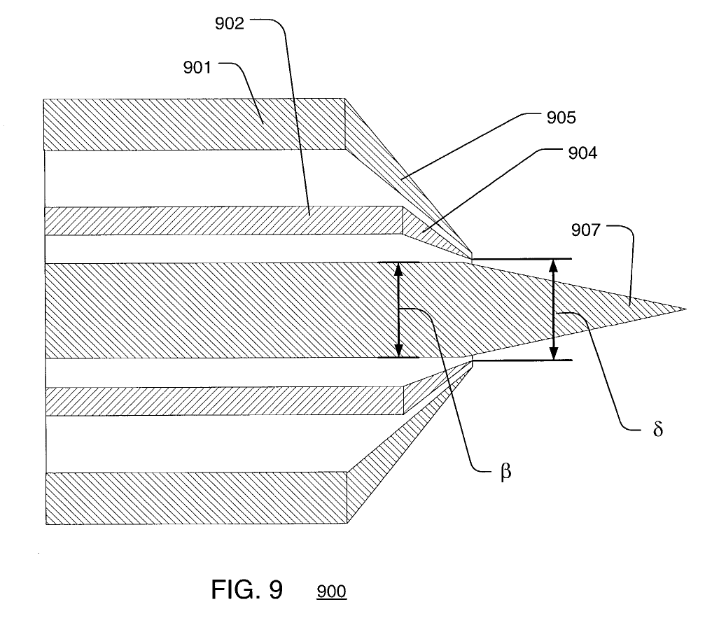

Referring now to FIG. 9, alternative embodiment 900 of the present invention is shown. Nozzle assembly 900 is an impinging coaxial jet mixer nozzle with a protruding conical centerbody. Nozzle assembly 900 comprises inner flow duct 902 disposed inside outer flow duct 901, a convergent tip 905 affixed to the discharge end of outer flow duct 901, a convergent tip 904 affixed to the discharge end of the inner flow duct 902, and protruding conical coaxial centerbody 907. Dimension β is the maximum diameter of the conical portion of centerbody 907. Dimension δ is the inner diameter of the opening of inner-nozzle tip 904. FIG. 9 refers to an alternative embodiment where β is less than or equal to 6.thereby allowing the full conical section of the centerbody to pass through the opening of inner nozzle tip 904.

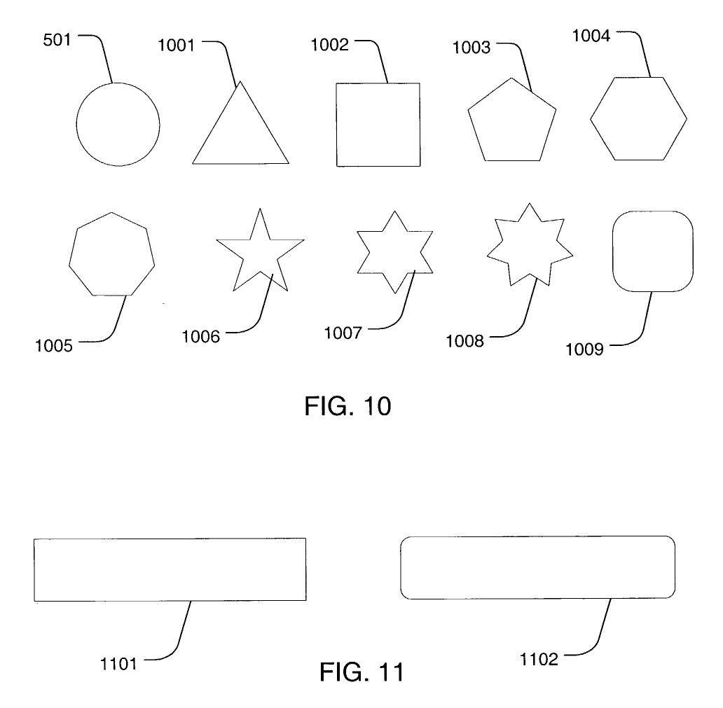

In alternative embodiments appropriate modifications may be made to the embodiments described herein, to employ centerbodies and nozzle tips having radial cross-sectional shapes other than circles, within the scope of the present invention. FIG. 10 shows 9 other possible shapes including regular polygons and star polygons. The set of shapes displayed in FIG. 10 is not exhaustive. Inner flow duct nozzle tip 404, outer flow duct nozzle tip 405, and protruding tip 412 of centerbody 407 can be machined as sets with matched, mating surfaces, enabling the enhanced performance associated with the centerbody design along with the more complicated jet cross-sectional shapes. Jets 403 and 406 would assume the corresponding cross-sectional shape of inner flow duct nozzle tip 404, outer flow duct nozzle tip 405, and protruding tip 412 of centerbody 407.

In alternative embodiments appropriate modifications may be made to the embodiments described herein, to employ centerbodies and nozzle tips having radial cross-sectional shapes that are oblong, within the scope of the present invention. FIG. 11 shows 2 possible oblong shapes including rectangular shape 1101 and rounded-rectangular shape 1102. The set of shapes displayed in FIG. 11 is not exhaustive. Inner flow duct nozzle tip 404, outer flow duct nozzle tip 405, and protruding tip 412 of centerbody 407 can be machined as sets with matched, mating surfaces, enabling the enhanced performance associated with the centerbody design along with the more complicated, oblong jet cross-sectional shapes. Jets 403 and 406 would assume the corresponding cross-sectional shape of inner flow duct nozzle tip 404, outer flow duct nozzle tip 405, and protruding tip 412 of centerbody 407.

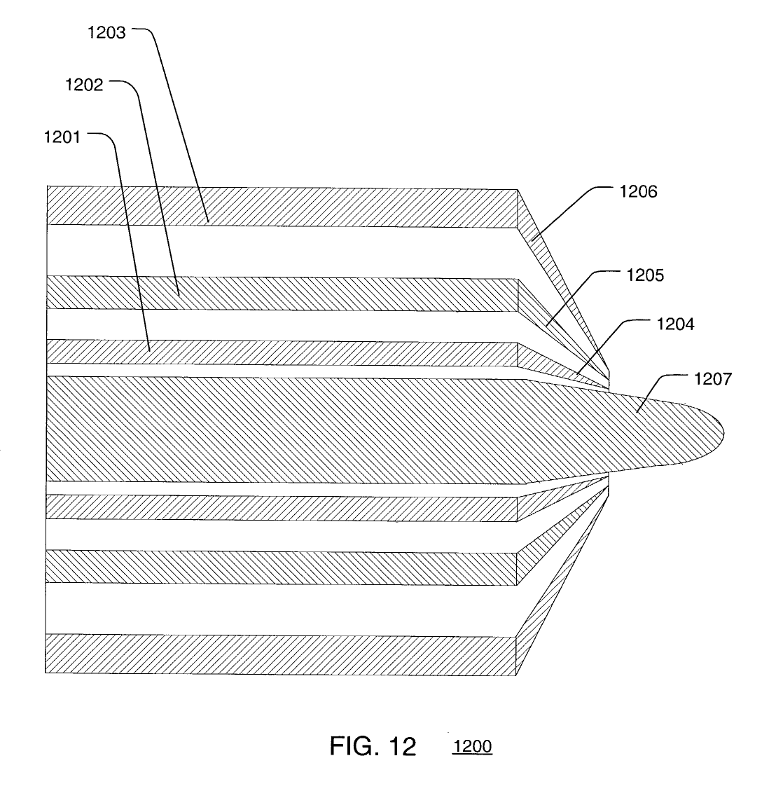

Referring now to FIG. 12, alternative embodiment 1200 of the present invention is shown. Nozzle assembly 1200 is an impinging coaxial jet mixer nozzle with a protruding conical centerbody for mixing three fluids. Nozzle apparatus 1200 comprises middle flow duct 1202 disposed inside outer flow duct 1203, inner flow duct 1201 disposed inside middle flow duct 1202, a convergent tip 1206 affixed to the discharge end of outer flow duct 1203, a convergent tip 1205 affixed to the discharge end of the middle flow duct 1202, a convergent tip 1204 affixed to the discharge end of the inner flow duct 1201, and protruding conical coaxial centerbody 1207. This alternative embodiment denotes the case where three or more fluid streams are mixed with the current invention through the use of additional coaxial flow ducts and nozzle tips.

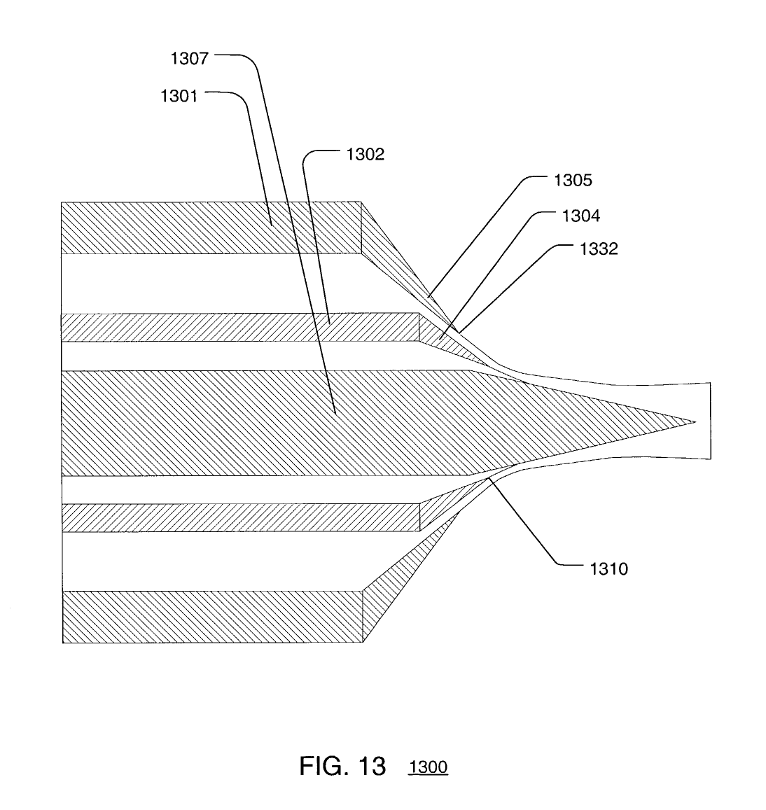

Referring now to FIG. 13, alternative embodiment 1300 of the present invention is shown. Nozzle assembly 1300 is an impinging coaxial jet mixer nozzle with a protruding centerbody having a shortened outer flow duct nozzle tip. Nozzle assembly 1300 comprises inner flow duct 1302 disposed inside outer flow duct 1301, a convergent tip 1305 affixed to the discharge end of outer flow duct 1301, a convergent tip 1304 affixed to the discharge end of the inner flow duct 1302, and protruding coaxial centerbody 1307. In contrast to the preferred embodiment shown in FIG. 4, outer flow duct nozzle tip 1305 is shortened such that discharge opening 1332 of outer flow duct nozzle tip 1305 is not proximate to discharge opening 1310 of inner flow duct nozzle tip 1304.

Referring again to FIG. 4, an alternative embodiment of the present invention can be configured by making appropriate ridges or grooves into the inner surface of outer nozzle tip 405, both the inner and outer surfaces of inner nozzle tip 404, and the outer surface of protruding tip 412 of centerbody 407. The purpose of these ridges and grooves would be to impart spin onto the jets as they exit the nozzle tips, aiding mixing under certain process conditions.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims (if any), giving full cognizance to equivalents in all respects.

What is claimed is:

1. An apparatus for mixing at least first and second fluids, the apparatus comprising:
(a) a first nozzle comprising a first flow duct having a convergent, tapered first nozzle tip having a first discharge opening;
(b) a second nozzle comprising a second flow duct having a convergent, tapered second nozzle tip having a second discharge opening, wherein the second nozzle is disposed coaxially around the first nozzle and the second discharge opening is substantially coaxially aligned with the first discharge opening, a second flow chamber being defined between the second nozzle and the first nozzle; and
(c) a centerbody disposed coaxially inside the first nozzle and having a protruding portion protruding axially beyond and through the first discharge opening, a first flow chamber being defined between the first nozzle and the centerbody, wherein:
during operation of said apparatus, the first fluid flowing in the first flow chamber and exiting through the first discharge opening forms a first annular fluid jet that is dispersed around said protruding portion; and
the second fluid flowing in the second flow chamber forms at the second discharge opening a second annular fluid jet that impinges upon the first annular fluid jet, thereby mixing the first and second fluids.

2. The apparatus of claim 1, wherein the centerbody is movable in the axial dimension relative to the first discharge opening and the centerbody comprises a body portion to which the protruding portion is attached.

3. The apparatus of claim 2, wherein the protruding portion is a tapered protruding portion, wherein the centerbody, the first nozzle, and the second nozzle have circular cross sections, and the centerbody comprises a substantially cylindrical main body portion and the protruding portion, wherein the outer diameter of the main body portion is larger than the diameter of the first discharge opening.

4. The apparatus of claim 3, wherein the centerbody has a lapped outer surface and the first nozzle tip has a lapped inner surface sufficient to provide a sealing fit therebetween when said centerbody is moved to an axial position at which the diameter of the protruding portion at the first discharge opening is equal to the diameter of the first discharge opening. Make similar changes to claim 5, 7.

5. The apparatus of claim 4, wherein the first nozzle tip is movable in the axial dimension relative to the second discharge opening, wherein the outer diameter of the first duct is larger than or equal to the diameter of the second discharge opening, and the centerbody comprises a body portion to which the tapered protruding portion is attached.

6. The apparatus of claim 5, wherein the first nozzle tip has a lapped outer surface and the second nozzle tip has a lapped inner surface sufficient to provide a sealing fit therebetween when said first nozzle tip is moved to an axial position at which the outer diameter of the first nozzle tip at the second discharge opening is equal to the diameter of the second discharge opening. Similar changes in claim 9.

7. The apparatus of claim 1, wherein a portion of the convergent, tapered first discharge end protrudes beyond the second discharge end.

8. The apparatus of claim 1, wherein the first discharge opening is axially proximate to the second discharge opening such that first nozzle tip does not protrude substantially beyond the second discharge opening and the second nozzle tip does not protrude substantially beyond the first discharge opening.

9. The apparatus of claim 1, further comprising a third nozzle, the third nozzle comprising a third flow duct having a convergent, tapered third nozzle tip having a third discharge opening, wherein the third nozzle is disposed coaxially around the second nozzle and the third nozzle tip is substantially coaxially aligned with the second nozzle tip, a third flow chamber being defined between the third nozzle and the second nozzle, wherein during operation of said apparatus, a third fluid flowing in the third flow chamber and exiting through the third discharge opening forms a third annular fluid jet that that impinges upon the first and second annular fluid jets, thereby mixing the first, second, and third fluids.

10. The apparatus of claim 1, wherein the radial, cross-sectional shape of the protruding portion of the centerbody is substantially circular.

11. The apparatus of claim 1, wherein the radial, cross-sectional shape of the protruding portion of the centerbody is substantially rectangular.

12. The apparatus of claim 1, wherein the radial, cross-sectional shape of the protruding portion of the centerbody is substantially of the shape of a regular polygon.

13. The apparatus of claim 1, wherein the radial, cross-sectional shape of the protruding portion of the centerbody is substantially of the shape of a star polygon.

14. The apparatus of claim 1, wherein the centerbody is movable in the axial dimension relative to the first discharge opening and the first nozzle tip is movable in the axial dimension relative to the second discharge opening.

15. The apparatus of claim 1, wherein the centerbody is movable in the axial dimension relative to the first discharge opening, the first nozzle tip is movable in the axial dimension relative to the second discharge opening, and the radial, cross-sectional shape of the protruding portion of the centerbody is substantially circular.

16. The apparatus of claim 1, wherein the centerbody is movable in the axial dimension relative to the first discharge opening, the first nozzle tip is movable in the axial dimension relative to the second discharge opening, the radial, cross-sectional shape of the protruding portion of the centerbody is substantially circular, the centerbody comprises a body portion to which the tapered protruding portion is attached wherein the outer diameter of the main body portion is larger than the diameter of the first discharge opening, and the centerbody has a lapped outer surface and the first nozzle tip has a lapped inner surface sufficient to provide a sealing fit therebetween when said centerbody is moved to an axial position at which the diameter of the protruding portion at the first discharge opening is equal to the diameter of the first discharge opening.

17. The apparatus of claim 1, wherein the centerbody is movable in the axial dimension relative to the first discharge opening, the first nozzle tip is movable in the axial dimension relative to the second discharge opening, the radial, cross-sectional shape of the protruding portion of the centerbody is substantially circular, the centerbody comprises a body portion to which the tapered protruding portion is attached wherein the outer diameter of the main body portion is larger than the diameter of the first discharge opening, the centerbody has a lapped outer surface and the first nozzle tip has a lapped inner surface sufficient to provide a sealing fit therebetween when said centerbody is moved to an axial position at which the diameter of the protruding portion at the first discharge opening is equal to the diameter of the first discharge opening, wherein the outer diameter of the first duct is larger than or equal to the diameter of the second discharge opening, and the first nozzle tip has a lapped outer surface and the second nozzle tip has a lapped inner surface sufficient to provide a sealing fit therebetween when said first nozzle tip is moved to an axial position at which the outer diameter of the first nozzle tip at the second discharge opening is equal to the diameter of the second discharge opening.

18. An apparatus for mixing at least first and second fluids, the apparatus comprising:
(a) first nozzle assembly means for forming a first annular fluid jet, consisting of the first fluid, at a first axial discharge position;
(b) a protruding member substantially coaxial with and inside the first annular fluid jet and protruding axially beyond the first axial discharge position, whereby the first annular fluid jet is dispersed around said protruding member; and
(c) second nozzle assembly means for forming a second annular fluid jet coaxial with and around the first annular fluid jet, the second annular fluid jet consisting of the second fluid, wherein the second annular fluid jet is formed at a second axial discharge position so that the second annular fluid jet impinges upon the first annular fluid jet as the first annular fluid jet is dispersed around said protruding portion, thereby mixing the first and second fluids.

19. The apparatus of claim 18, wherein:
the first and second nozzle assembly means comprise:
(1) a first nozzle comprising a first flow duct having a convergent, tapered first nozzle tip having a first discharge opening, wherein the first axial discharge position is the axial position of the first discharge opening;
(2) a second nozzle comprising a second flow duct having a convergent, tapered second nozzle tip having a second discharge opening, wherein the second axial discharge position is the axial position of the second discharge opening, wherein the second nozzle is disposed coaxially around the first nozzle and the second discharge opening is substantially coaxially aligned with the first discharge opening, a second flow chamber being defined between the second nozzle and the first nozzle; and
(3) a centerbody disposed coaxially inside the first nozzle and having a protruding portion protruding axially beyond and through the first discharge opening, a first flow chamber being defined between the first nozzle and the centerbody, wherein the protruding member comprises the protruding portion of the centerbody, wherein:
during operation of said apparatus, the first fluid flowing in the first flow chamber and exiting through the first discharge opening forms the first annular fluid jet that is dispersed around said protruding portion; and
the second fluid flowing in the second flow chamber forms at the second discharge opening the second annular fluid jet that impinges upon the first annular fluid jet, thereby mixing the first and second fluids.

20. The apparatus of claim 19, wherein the protruding portion is a tapered protruding protion, wherein the centerbody, the first nozzle, and the second nozzle have circular cross sections, and the centerbody comprises a substantially cylindrical main body portion and the protruding portion, wherein the outer diameter of the main body portion is larger than the diameter of the first discharge opening.

21. A method for mixing at least first and second fluids, the method comprising the steps of:
(a) forming a first annular fluid jet, consisting of the first fluid, at a first axial discharge position and dispersing the first annular fluid jet around a protruding member substantially coaxial with and inside the first annular fluid jet and protruding axially beyond the first axial discharge position;
(b) forming a second annular fluid jet coaxial with and around the first annular fluid jet and consisting of the second fluid at a second axial discharge position so that the second annular fluid jet impinges upon the first annular fluid jet as the first annular fluid jet is dispersed around said protruding portion, thereby mixing the first and second fluids.
